(19) United States
(12) Patent Application Publication
(10) Pub. No.: US 2017/0045471 A1
(43) Pub. Date: Feb. 16, 2017

(54) NOx CONCENTRATION MEASUREMENT SYSTEM

(71) Applicant: DENSO CORPORATION, Kariya-city, Aichi-pref. (JP)

(72) Inventors: Eriko MAEDA, Kariya-city, Aichi-pref. (JP); Keigo MIZUTANI, Nishio-city, Aichi-pref. (JP); Takehito KIMATA, Kariya-city, Aichi-pref. (JP); Yuusuke TOUDOU, Kariya-city, Aichi-pref. (JP)

(21) Appl. No.: 15/305,410

(22) PCT Filed: Apr. 1, 2015
(86) PCT No.: PCT/JP2015/060359

§ 371 Date: Oct. 20, 2016

(30) Foreign Application Priority Data
Apr. 22, 2014 (JP) 2014-088468
Feb. 9, 2015 (JP) 2015-023370

(51) Int. Cl. G01N 27/407; G01N 27/416

(52) U.S. Cl. CPC G01N 27/407; G01N 27/416

(57) ABSTRACT

A NOx concentration measurement system has a NOx sensor, a detection section, a NH₃ concentration estimation section and a calculation section. The NOx sensor measures a sum concentration c₄ of a concentration of NOx (a concentration c₁ of combustion derived NOx) in exhaust gas g, and a concentration of NO (concentration c₃ of derived NO which has been derived from NH₃) oxidized from NH₃. The calculation section calculates the concentration c₃ of derived NO by using a concentration c₂ of NH₃ contained in outside exhaust gas which is present around the NOx sensor, not inside of the NOx sensor, and at least one of an air fuel ratio A/F, a concentration of O₂ and a concentration of H₂O. The concentration c₁ of the is calculated based on the sum concentration c₄ and the concentration c₃ of derived NO.

### TECHNICAL FIELD

The present invention relates to NOx concentration measurement systems capable of measuring a concentration of NOx in exhaust gas which contains NOx and NH₃.

### BACKGROUND ART

Motor vehicles, etc. are generally equipped with a NOx sensor. The NOx sensor measures a concentration of NOx contained in exhaust gas. There is a known NOx sensor having a gas chamber, an oxygen pump cell and a cell sensor. (see the following patent document 1). Exhaust gas is supplied to the gas chamber. The oxygen pump cell adjusts a concentration of oxygen gas contained in the exhaust gas in the gas chamber. The sensor cell measures a concentration of NOx in the exhaust gas in the gas chamber.

The sensor cell is composed of a solid electrolyte body and electrodes made of noble metal. The solid electrolyte body has oxygen ion conductivity. The electrodes are formed on surfaces of the solid electrolyte body. NOx gas is converted to oxygen ions on the surface of the electrode in the NOx sensor. A current of the generated oxygen ions which flow in the solid electrolyte body is detected in order to measure the concentration of NOx.

Recently, there has been developed a method of measuring a concentration of NOx contained in exhaust gas which contains NH₃ in addition to NOx. There is a urea SCR system as a background technique of this method. In the urea SCR system, urea water is injected into exhaust gas which contains NOx, in order to generate NH₃. A chemical reaction occurs between NOx and NH₃ to generate the harmless gas N₂ and H₂O. Because the exhaust gas processed by the urea SCR system contains non-reacted NOx and NH₃, there is a demand to correctly measure a concentration of NOx remained in exhaust gas and to perform a feedback control in order to adjust an injection amount of urea water and engine control.

By the way, there is a problem that it is difficult to correctly measure a concentration of NOx contained in exhaust gas which contains both NOx and NH₃. NH₃ is oxidized in the NOx sensor to produce NO. For this reason, the NOx sensor detects both NOx contained in the exhaust gas and NO generated by the oxidation of NH₃. Accordingly, the NOx sensor cannot measure a concentration of NOx only. In other words, the NOx sensor only measures a sum of the concentration of combustion derived NOx (a concentration of NOx which has originally been contained in the exhaust gas) contained in exhaust gas and a concentration of NO (a concentration of derived NO which has been derived from NH₃) generated by the oxidation of NH₃.

In order to solve the problem previously described, the following method has been considered. Because it can be estimated that a concentration of derived NO which has been derived from NH₃ is approximately equal to a concentration of NH₃ contained in outside exhaust gas which is present around the NOx sensor, not inside of the Nox sensor, an additional sensor is required and arranged to measure a concentration of the NH₃ contained in the outside exhaust gas. The method further subtracts the concentration of the NH₃ contained in the outside exhaust gas measured by the additional sensor from the sum concentration measured by the NOx sensor so as to obtain the concentration of NOx originally contained in the exhaust gas. It has been considered that this method measures a concentration of the combustion derived NOx with high accuracy.

### CITATION LIST

### Patent Literature

[Patent document 1] Japanese patent laid open publication No. JP 2011-75546.

### SUMMARY OF INVENTION

### Technical Problem

However, the method previously described cannot measure a concentration of combustion derived NOx with high accuracy. That is, heat energy is supplied to NH₃ when it is introduced into the gas chamber, and a part of NH₃ is chemically changed to N₂. The NOx sensor cannot detect derived N₂ which has been derived from a part of the NH₃. That is, not all NH₃ is chemically converted to NO to be detected by the NOx sensor. For this reason, there are many cases in which a concentration of derived NO which has been derived from NH₃ is lower than a concentration of the NH3 in the outside exhaust gas which is present around the NOx sensor, not inside of the NOx sensor.

As previously explained, the NOx sensor measures a sum concentration of a concentration of combustion derived NOx contained in exhaust gas and a concentration of derived NO which has been derived from NH₃. The concentration of the derived NO which has been derived from NH₃ is different from a concentration of the NH3 contained in the outside exhaust gas. Accordingly, it is impossible to measure a concentration of combustion derived NOx contained in exhaust gas by the subtraction of the concentration of the NH3, which is contained in the outside exhaust gas which is present around the NOx sensor, not inside of the NOx sensor, from the sum concentration measured by the NOx sensor with high accuracy.

Accordingly, it is an object of the present invention to provide a NOx concentration measurement system capable of measuring a concentration of NOx contained in exhaust gas which contains NOx and NH₃ with high accuracy.

### Solution to Problem

In accordance with one aspect of the present invention, there is provided a NOx concentration measurement system capable of measuring a concentration of NOx contained in exhaust gas which contains NOx and NH₃. The NOx concentration measurement system is equipped with a NOx sensor, a detection section, a NH₃ concentration estimation section, and a calculation section.

The NOx sensor is equipped with a gas chamber, a sensor cell and a gas introduction section. Exhaust gas is introduced into the gas chamber. The sensor cell has a solid electrolyte body having oxygen ion conductivity. The sensor cell has a plate shape. Electrodes are formed on the surfaces of the solid electrolyte body. The Exhaust gas is introduced into the gas chamber through the gas introduction section. The NOx sensor measures a sum concentration of a concentration of combustion derived NOx, which is contained in the exhaust gas, and a concentration of derived NO which has been derived from NH₃ as a concentration of NO generated by oxidization of the NH₃. The detection section detects at least one of an air fuel ratio of the exhaust gas, a concentration of O₂ contained in the exhaust gas and a concentration of H₂O contained in the exhaust gas. The NH₃ concentration estimation section estimates a concentration of NH₃ contained in the outside exhaust gas which is present around the NOx sensor, not inside of the NOx sensor before the introduction of the exhaust gas into the gas introduction section of the NOx sensor. The calculation section calculates the concentration of the derived NO which has been derived from NH₃ on the basis of the concentration of the NH3 in the outside exhaust gas and at least one of the air fuel ratio, the concentration of O₂ and the concentration of H₂O. The calculation section calculates the concentration of the combustion derived NOx on the basis of the sum concentration previously described and the concentration of the derived NO which has been derived from NH₃.

The inventors according to the present invention have studied the problems previously described, and found that presence of O₂ and H₂O contained in exhaust gas affects a chemical reaction of NH₃ contained in the exhaust gas to generate N₂. That is, heat energy is supplied to exhaust gas in the gas introduction section when the exhaust gas is introduced into the gas chamber of a NOx sensor, and a chemical reaction occurs on the basis of the following equation (1), and further chemical reactions (2) and (3) occur:

4NH₃+5O₂→4NO+6H₂O (1),

4NH₃+6O₂→5N₂+6H₂O (2), and

4NH₃+4NO+O₂→4N₂+6H₂O (3).

As can be understood from the above equation (1), the chemical reaction progresses to the right term in the equation (1) when a concentration of H₂O contained in exhaust gas is low, and NH₃ is changed to NO. Further, the chemical reaction progresses to the right term in the equation (2) and the right term in the equation (3) to change NO to N₂. That is, when a concentration of H₂O contained in exhaust gas is low, a chemical reaction of NH₃ to N₂ progresses, and the NOx sensor detects a low amount of NO. Therefor a concentration of derived NO which has been derived from NH₃ becomes lower than a concentration of the NH3 in the outside exhaust gas which is present around the NOx sensor, not inside of the NOx sensor.

As previously explained, there is a constant relationship in concentration between the NH₃ in the outside exhaust gas, H₂O and derived NO which has been derived from NH₃. Accordingly, it is possible to calculate a concentration of the derived NO which has been derived from NH₃ by measuring a concentration of NH₃ which present outside of the NOx sensor, and a concentration of H₂O.

In addition, as can be understood from the chemical equation (1), the chemical reaction progresses to the right term of the equation (1) when a concentration of O₂ contained in exhaust gas is high. Further, the chemical reaction progresses to the right term of the equation (3) to change NO to N₂. That is, when a concentration of H₂O contained in exhaust gas is high, a chemical reaction of NH₃ to N₂ progresses, and the NOx sensor detects a low amount of NO. Therefore a concentration of the derived NO which has been derived from NH₃ becomes lower than a concentration of the NH3 in the outside exhaust gas which is present around the NOx sensor, not inside of the NOx sensor.

As previously described, there is a constant relationship in concentration between the NH3, contained in the outside exhaust gas, O₂ and the derived NO which has been derived from NH₃. Accordingly, it is possible to calculate a concentration of the derived NO which has been derived from NH₃ on the basis of the constant relationship which has been obtained by measuring a concentration of the NH₃ contained in the outside exhaust gas and a concentration of O₂.

In addition, there is a constant relationship between an air fuel ratio and a concentration of O₂, and a constant relationship between the air fuel ratio and a concentration of H₂O. Accordingly, it is possible to calculate a concentration of the derived NO which has been derived from NH₃ by measuring a concentration of the NH₃ contained in the outside exhaust gas which is outside of the NOx sensor and the air fuel ratio.

As previously described, it is possible to calculate a correct concentration of the combustion derived NOx with high accuracy on the basis of a concentration of the derived NO which has been derived from NH₃ and a sum concentration (which is a sum concentration of a concentration of combustion derived NOx and a concentration of the derived NO which has been derived from NH₃) measured by the NOx sensor. For example, it is possible to calculate the concentration of the combustion derived NOx with high accuracy by subtracting the concentration of the derived NO which has been derived from NH₃ from the sum concentration. Further, it is possible to calculate the concentration of combustion derived NOx with high accuracy on the basis of using data in a database, the sum concentration and the concentration of the derived NO which has been derived from NH₃, where the database has stored the relationship between the sum concentration and the concentration of the derived NO which has been derived from NH₃.

As previously described, the present invention can provide the NOx concentration measurement system capable of measuring a concentration of NOx with high accuracy in exhaust gas which contains NOx and NH₃.

### BRIEF DESCRIPTION OF DRAWINGS

FIG. 1 is a view showing an overall structure of a NOx concentration measurement system according to a first exemplary embodiment of the present invention.

FIG. 2 is a view showing a cross section of a NOx sensor along the line II-II shown in FIG. 1.

FIG. 3 is a view showing a cross section of the NOx sensor along the line III-III shown in FIG. 1, along with a schematic of electrical connections thereto.

FIG. 4 is an exploded perspective view of the NOx sensor used in the NOx concentration measurement system according to the first exemplary embodiment shown in FIG. 1.

FIG. 5 is a view showing a partially enlarged cross section of the NOx sensor shown in FIG. 1.

FIG. 6 is a conceptual view of the NOx concentration measurement system according to the first exemplary embodiment shown in FIG. 1.

FIG. 7 is a conceptual view showing a relationship between a concentration of combustion derived NOx contained in exhaust gas, a concentration of NH₃ contained in outside exhaust gas which is present around the NOx sensor, not inside of the NOx sensor, a concentration of the combustion derived NOx measured by the NOx sensor, a concentration of derived NO which has been derived from NH₃ measured by the NOx sensor, and a concentration of the combustion derived NOx calculated by the NOx concentration measurement system according to the first exemplary embodiment shown in FIG. 1.

FIG. 8 is a graph showing a relationship between a concentration of H₂O and a NH₃ detection sensitivity in the NOx concentration measurement system according to the first exemplary embodiment.

FIG. 9 is a graph showing a relationship between a concentration of O₂ and the NH₃ detection sensitivity in the NOx concentration measurement system according to the first exemplary embodiment.

FIG. 10 is a graph showing a relationship between A/F and Ip measured by the NOx concentration measurement system according to the first exemplary embodiment.

FIG. 11 is a graph showing a relationship between A/F and a concentration of O₂ measured by the NOx concentration measurement system according to the first exemplary embodiment.

FIG. 12 is a graph showing a relationship between A/F and a concentration of H₂O measured by the NOx concentration measurement system according to the first exemplary embodiment.

FIG. 13 is a graph showing a relationship between a thickness of a trap layer and the NH₃ detection sensitivity in the NOx concentration measurement system according to the first exemplary embodiment.

FIG. 14 is a graph showing a relationship between a thickness of a gas introduction section and the NH₃ detection sensitivity in the NOx concentration measurement system according to the first exemplary embodiment.

FIG. 15 is a view showing a cross section of the NOx sensor having an aperture section as the gas introduction section in the NOx concentration measurement system according to the first exemplary embodiment.

FIG. 16 is a graph showing a relationship between a concentration of NH₃ in the exhaust gas and an output of the NOx sensor which has not been compensated by using A/F in the NOx concentration measurement system according to the first exemplary embodiment.

FIG. 17 is a graph showing a relationship between a concentration of NH₃ in test gas and an output of the NOx sensor which have been compensated by using the A/F in the NOx concentration measurement system according to the first exemplary embodiment.

FIG. 18 is a view showing a conceptual view of an experimental device for the NOx concentration measurement system according to a second exemplary embodiment of the present invention.

FIG. 19 is a graph showing a relationship at given gas flow rates between a temperature at a gas inlet and a strength of a detection signal of a sensor cell in the NOx concentration measurement system according to the second exemplary embodiment of the present invention.

FIG. 20 is a graph showing a relationship between a concentration of H₂O and a NH₃ detection sensitivity, in which a lateral axis of the graph is divided to a region of not less than 40 of A/F and a region of not more than 40 of the A/F, in the NOx concentration measurement system according to the second exemplary embodiment of the present invention.

FIG. 21 is a graph showing a relationship between a concentration of O₂ and a NH₃ detection sensitivity, in which the lateral axis of the graph is divided to a region of not less than 20 of A/F and a region of not more than 20 of the A/F, in the NOx concentration measurement system according to the second exemplary embodiment of the present invention.

FIG. 22 is a flow chart showing the operation of a calculation section 7 in the in the NOx concentration measurement system according to the second exemplary embodiment of the present invention.

FIG. 23 is a conceptual view of a relationship between a concentration of combustion derived NOx contained in exhaust gas, a concentration of NH₃ contained in outside exhaust gas which is present outside of a NOx sensor, a concentration of the combustion derived NOx measured by the NOx sensor, a concentration of derived NO which has been derived from NH₃ measured by the NOx sensor, and a concentration of the combustion derived NOx calculated by the NOx concentration measurement system according to a first comparative example.

### DESCRIPTION OF EMBODIMENTS

The NOx concentration measurement system according to the present invention is capable of measuring a concentration of NOx contained in exhaust gas output from an internal combustion engine with high accuracy and high efficiency. It is possible to apply the NOx concentration measurement system according to the present invention to various types of internal combustion engines. For example, it is possible to apply the NOx concentration measurement system according to the present invention to motor vehicles equipped with a urea SCR system.

### EMBODIMENTS

### First Exemplary Embodiment

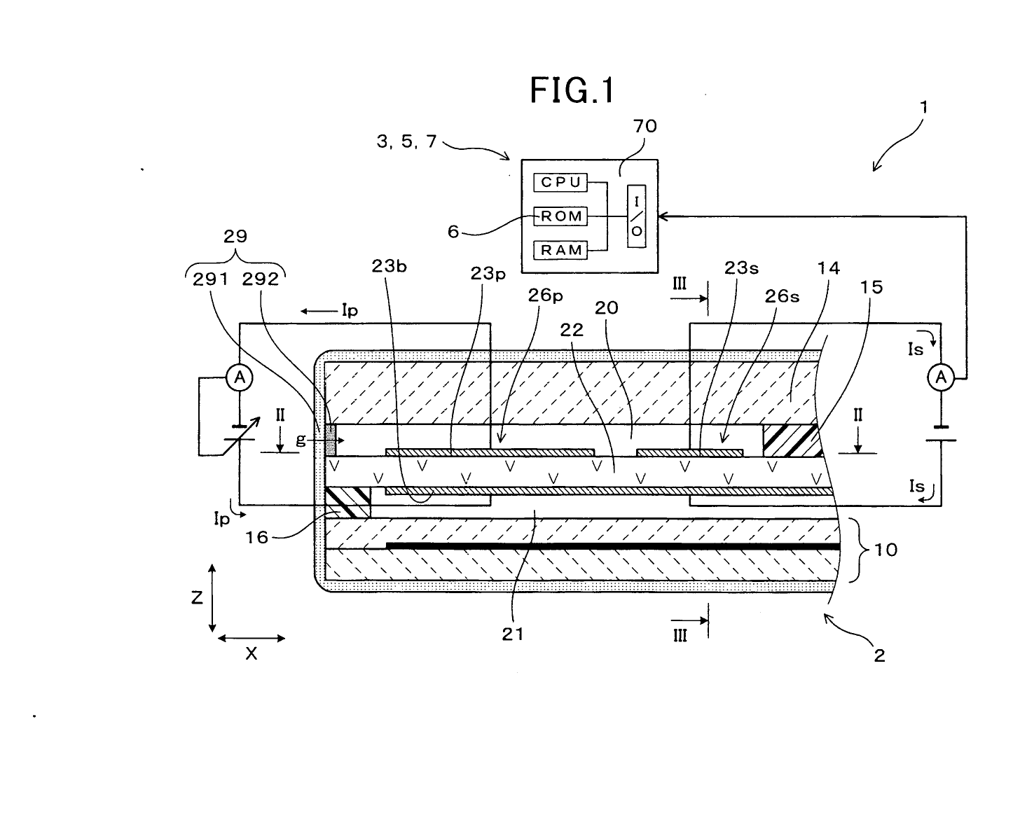

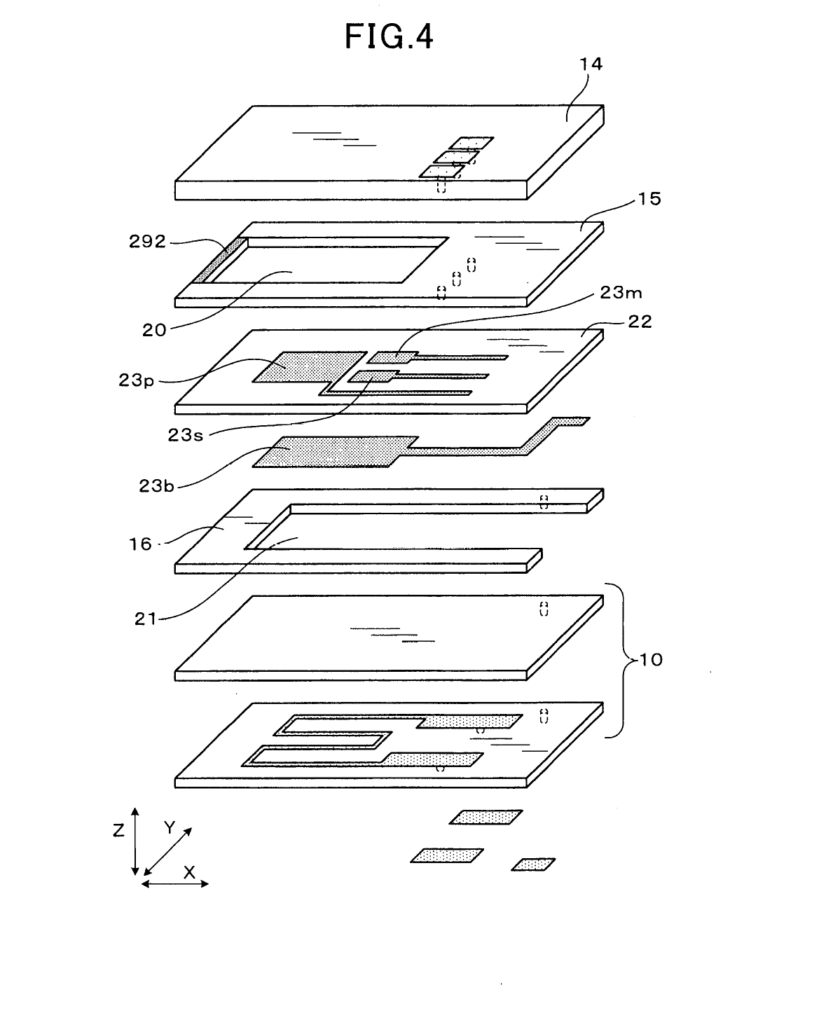

A description will be given of the NOx concentration measurement system according to the first exemplary embodiment with reference to FIG. 1 to FIG. 15. As shown in FIG. 1, the NOx concentration measurement system according to the first exemplary embodiment is equipped with a NOx sensor 2, a detection section 3, a NH₃ concentration estimation section 5 and a calculation section 5.

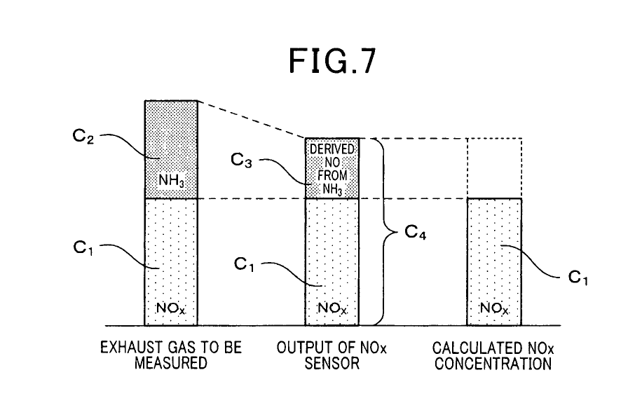

The NOx sensor 2 has a gas chamber 20, a sensor cell 26s and a gas introduction section 29. The sensor cell 26s is composed of an electrode 23 (23s, 23b) formed on a surface of the solid electrolyte body 22 of oxygen ion conductivity having a plate shape. The gas introduction section 29 is a gas passage through which exhaust gas g is introduced into the gas chamber 20 from outside of the NOx concentration measurement system 1. The NOx concentration measurement system 1 has a structure in which the sensor cell 26s measures a sum concentration c₄ of a concentration of NOx (as a concentration c₁ of combustion derived NOx, see FIG. 7) contained in the exhaust gas g and a concentration of NO (as a concentration c₃ of derived NO which has been derived from NH₃) which has been generated by oxidation of NH₃.

The detection section 3 detects at least one of an air fuel ratio A/F of the exhaust gas g and a concentration of H₂O contained in the exhaust gas g. The NH₃ concentration estimation section 5 estimates a concentration c₂ (see FIG. 7) of NH₃ contained in the outside exhaust gas which is present around the NOx sensor, not inside of the NOx sensor as a concentration of NH₃ in the exhaust gas g before the supply to the gas introduction section 29.

The calculation section 5 calculates a concentration c₃ of the derived NO which has been derived from NH₃ on the basis of the concentration c₂ of the NH₃ contained in the outside exhaust gas and at least one of the air fuel ratio A/F, the concentration of O₂ and the concentration of H₂O. The calculation section 5 calculates a concentration c₁ of the combustion derived NOx on the basis of the sum concentration c₄ and the concentration c3 of the derived NO.

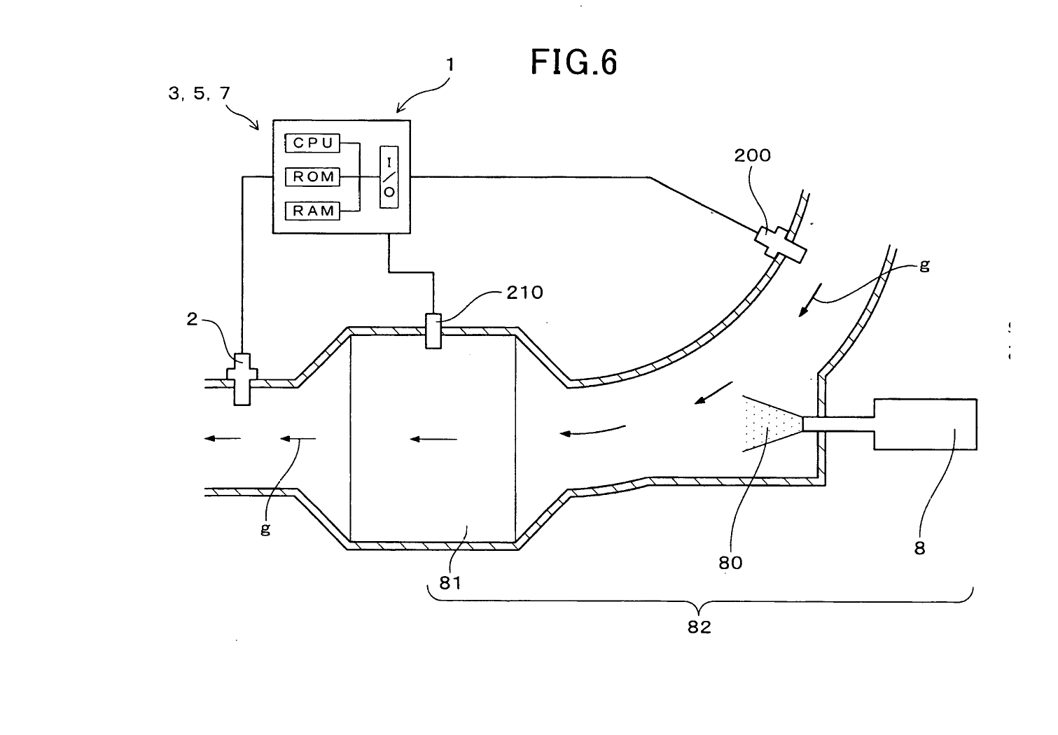

As shown in FIG. 6, the NOx concentration measurement system 1 according to the first exemplary embodiment is arranged to calculate the concentration of NOx (the concentration c₁ of combustion derived NOx) contained in exhaust gas which has been processed by a urea SCR system 82. The urea SCR system 82 is arranged to convert NOx contained in exhaust gas emitted from an internal combustion engine to N₂, H₂O, etc. In the urea SCR system 82, urea water 80 is injected through a urea water injection valve 8 into exhaust gas g, and a SCR catalyst 81 performs a chemical reaction of NH₃ and NOx generated by using the urea water 80 in order to convert NOx to N₂, H₂O, etc.

The exhaust gas g, after has passed through the SCR catalyst 81, contains non reacted NOx and NH₃. The NOx concentration measurement system 1 calculates a NOx concentration (as the concentration c₁ of the combustion derived NOx) contained in this exhaust gas g. An injection amount of the urea water 80 is adjusted on the basis of the calculated NOx concentration.

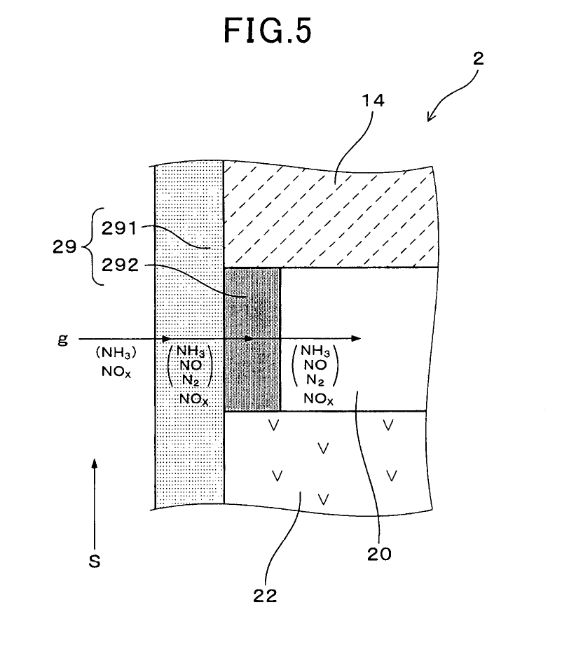

As shown in FIG. 5, the exhaust gas g is introduced into the gas chamber 20 through the gas introduction section 29. The gas introduction section 29 is composed of a trap layer 291 and a diffusion layer 292. The trap layer 291 traps poison material contained in the exhaust gas g. The diffusion layer 292 limits a flow speed of the exhaust gas g. For example, the trap layer 291 and the diffusion layer 292 are made of alumina.

There is a possible case in which a part of NH₃ in the exhaust gas g is converted to NO in a chamber S arranged before the gas introduction section 29. Further, thermal energy is supplied to the exhaust gas g when flowing in the gas introduction section 29, and a part of NH₃ contained in the exhaust gas g is converted to NO and N₂. Accordingly, the exhaust gas g is introduced into the gas chamber 20, which contains combustion derived NOx and NH₃ which have been present in the exhaust gas g, and NO and N₂ derived from NH₃. A pump electrode 23p oxidizes this NH₃ to generate NO. The pump electrode 23p will be explained below in detail. The sensor cell 28 measures the sum concentration c₄ of the concentration of NO (as the concentration c₃ of the derived NO which has been derived from NH₃) and the concentration of NOx (as the concentration c₁ of the combustion derived NOx) contained in the exhaust gas. It is difficult for the sensor cell 26s to detect concentration c₃ of the derived NO which has been derived from NH₃ and the concentration c₁ of the combustion derived NOx, independently.

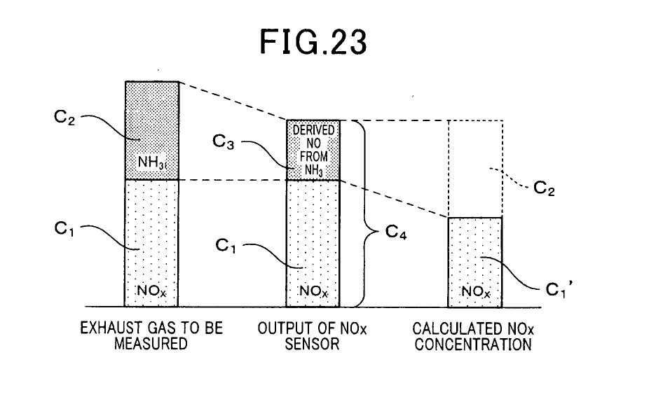

As shown in FIG. 7, a concentration of NO generated by the oxidation of NH₃ is lower than the concentration c₂ of the NH₃ contained in the outside exhaust gas which is present around the NOx sensor, not inside of the NOx sensor. As previously described, a part of NH₃ in the exhaust gas g is converted to N₂ in the gas introduction section 29. As shown in FIG. 23, when the concentration c₂ of the NH₃ contained in the outside exhaust gas is subtracted from the sum concentration c₄ measured by the NOx sensor 2, a concentration c_{1′} of the combustion derived NOx as the subtraction result becomes lower than an actual concentration c₁ of the combustion derived NOx. In the first exemplary embodiment previously described, the calculation section 7 calculates the concentration c₃ of the derived NO which has been derived from NH₃, and subtracts the concentration c₃ of the derived NO from the sum concentration c₄. This calculates a correct concentration c₁ of the combustion derived NOx with high accuracy.

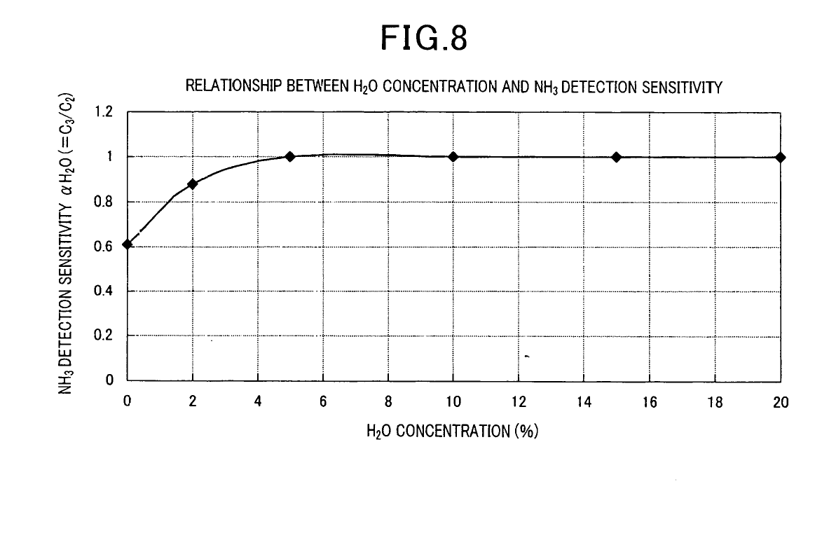

A description will be given of a method of calculating the concentration c₃ of the derived NO in detail. As shown in FIG. 8, there is a constant relationship between a concentration of H₂O contained in exhaust gas g and a NH₃ detection sensitivity of the NOx sensor. The NH₃ detection sensitivity of the NOx sensor 2 can be expressed by the following equation:

NH₃ detection sensitivity=Concentration c₃ of derived NO which has been derived from NH₃/Concentration c₂ of NH₃ contained in outside exhaust gas which is present outside of NOx sensor.

As can be understood from the graph shown in FIG. 8, when the concentration of H₂O in the exhaust gas g is low, the concentration c₃ of the derived NO which has been derived from NH₃ is reduced, and the NH₃ detection sensitivity becomes reduced. This means that a conversion ratio of NH₃ to N₂ increases when the concentration of H₂O in the exhaust gas g is low.

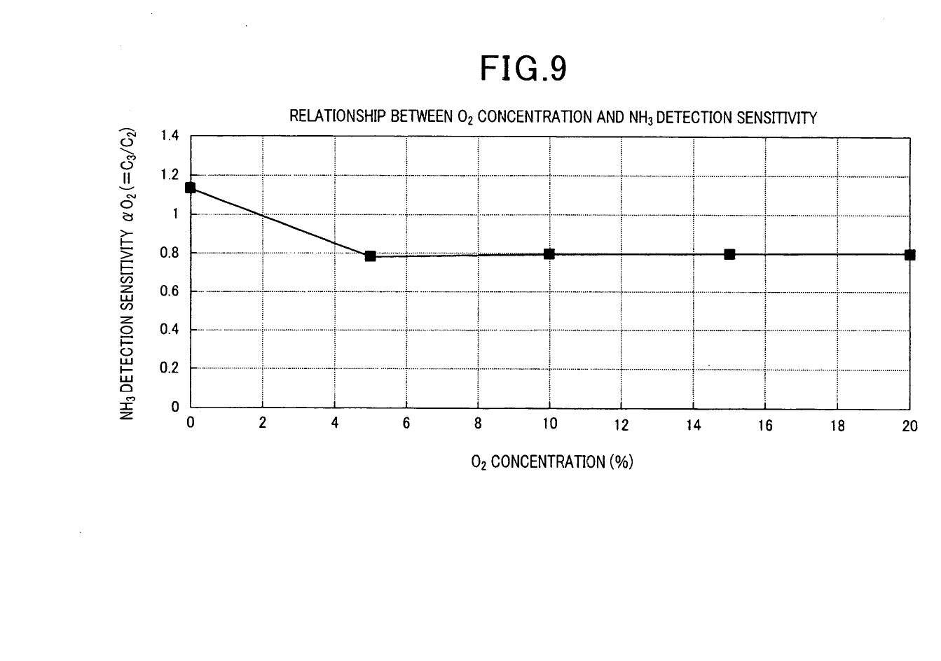

As shown in FIG. 9, there is also a constant relationship between the concentration of O₂ in the exhaust gas g and the NH₃ detection sensitivity of the NOx sensor. When the concentration of O₂ in the exhaust gas g increases, the concentration c₃ of the derived NO which has been derived from NH₃ is reduced, and the NH₃ detection sensitivity becomes reduced. This means that a ratio of converting NH₃ to N₂ increases when the concentration of O₂ in the exhaust gas g is high.

For example, it is possible for the following method to calculate the concentration c₃ of the derived NO which has been derived from NH₃. That is, a function of the relationship shown in FIG. 8 is stored in advance in the memory section 6 of the calculation section 7 (see FIG. 1). The NH₃ detection sensitivity α_{H2O} is calculated on the basis of the detected concentration of H₂O by using this function. The NH₃ detection sensitivity α_{H2O} and the concentration c₂ of the NH₃ are inserted into the following equation (4) in order to obtain the concentration c₃ of the derived NO.

c₃=α_{H2O}×c₂ (4).

Further, it is possible to calculate the concentration c₃ of the derived NO by the following method. That is, a function of the relationship shown in FIG. 9 is stored in advance in the memory section 6. The NH₃ detection sensitivity α_{HO2} is calculated on the basis of the detected concentration of O₂ by using this function. The NH₃ detection sensitivity α_{O2} and the concentration c₂ of the NH₃ contained in the outside exhaust gas are inserted into the following equation (5) in order to obtain the concentration c₃ of the derived NO.

c₃=α_{O2}×c₂ (5).

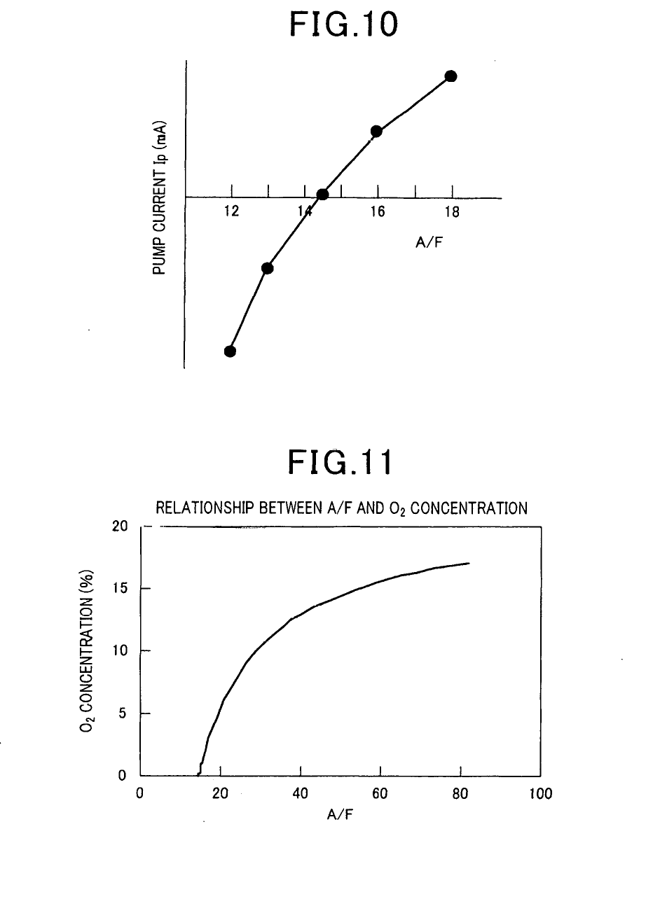

It is also possible to use the following method. That is, there is a relationship shown in FIG. 10 between a pump cell current Ip and the air fuel ratio A/F of the exhaust gas g. The pump cell current Ip flows in the pump cell 26p (see FIG. 1). This relationship will be explained below. Accordingly, it is possible to calculate the air fuel ratio A/F by using a detected value of the pump cell current Ip and the graph shown in FIG. 10. Still further, there is a relationship between the air fuel ratio A/F and the concentration of O₂ shown in FIG. 11. Accordingly, it is possible to calculate the concentration of O₂ contained in the exhaust gas g by using the detected air fuel ratio A/F and the graph shown in FIG. 11. Still further, it is possible to calculate the NH₃ detection sensitivity α_{O2} by using the obtained concentration of O₂ and the graph shown in FIG. 9. Accordingly, it is possible to calculate the concentration c₃ of the derived NO by using the equation (5).

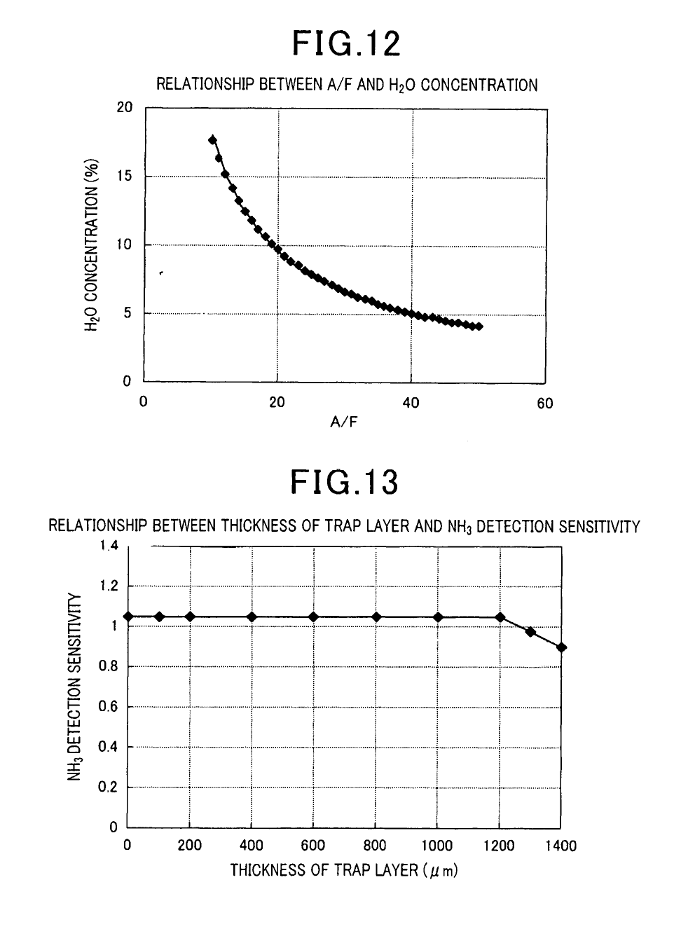

Similarly, it is also possible to use the following method. As previously described, the air fuel ratio A/F of the exhaust gas g is calculated by using the measured value of the pump cell current Ip and the graph shown in FIG. 10. Because there is the relationship shown in FIG. 12 between the air fuel ratio A/F of the exhaust gas g and the concentration of H₂O, it is possible to calculate the concentration of H₂O contained in the exhaust gas g by using the obtained air fuel ratio A/F and the graph shown in FIG. 12. Still further, it is possible to calculate the NH₃ detection sensitivity α_{HO2} by using the obtained concentration of H₂O and the graph shown in FIG. 8. Accordingly, it is possible to calculate the concentration c₃ of the derived NO by using the equation (4). There is the relationship shown in FIG. 12 between the concentration of H₂O and the air fuel ratio A/F. the exhaust gas g contains water vapor in the urea water 80 (see FIG. 6). Accordingly, it is preferable to compensate the concentration of H₂O on the basis of an injection amount of the urea water 80.

It is not necessary to calculate the concentration of O₂ and the concentration of H₂O on the basis of the air fuel ratio A/F when the air fuel ratio A/F is used. That is, it is also possible to use a program performing the function of the calculation section 7 (see FIG. 1) to directly calculate the concentration c₃ of the derived NO which has been derived from NH₃ by using the air fuel ratio A/F and the concentration c₂ of the NH₃ contained in the outside exhaust gas.

When the concentration c₃ of the derived NO is calculated with high accuracy by using the methods previously described, it is possible to calculate the concentration c₁ of the combustion derived NOx with high accuracy by subtracting the concentration c₃ of the derived NO from the sum concentration c₄ (see FIG. 7).

A description will now be given of a detailed structure of the NOx sensor 2. As shown in FIG. 1 to FIG. 4, the NOx sensor 2 has an insulation plate 14, a first spacer 15, the solid electrolyte body 22, a second spacer 16 and a heater section 10. The gas chamber 20 is formed between the solid electrolyte body 22 and the insulation plate 14. A reference gas chamber 21 is formed between the solid electrolyte body 22 and the heater section 10. Atmospheric air as a reference gas is introduced into the reference gas chamber 21.

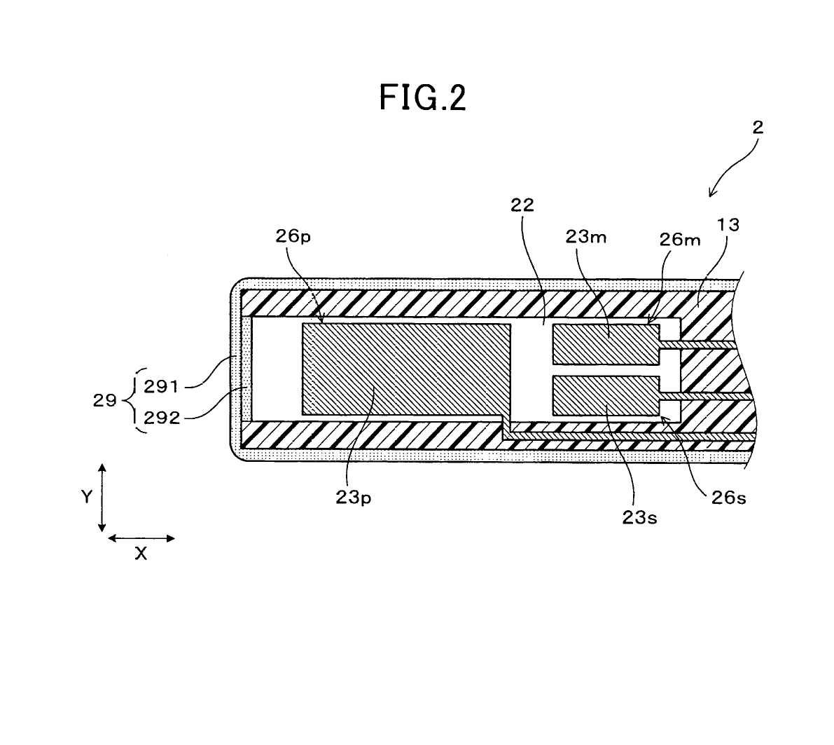

As shown in FIG. 1 and FIG. 2, the pump electrode 23p, a sensor electrode 23s and a monitor electrode 23m are formed on a surface of the solid electrolyte body 22 at the gas chamber 20 side. A reference electrode 23b is formed on a surface of the solid electrolyte body 22 at the reference gas chamber 21 side. The pump electrode 23p and the monitor electrode 23m are made of Pt—Au alloy metal which is inactive material to decompose NOx. In addition, the sensor electrode 23s is made of Pt—Rh alloy metal which is active material to decompose NOx.

The pump electrode 23p, the solid electrolyte body 22 and the reference electrode 23b form the pump cell 26p. The sensor electrode 23s, the solid electrolyte body 22 and the reference electrode 23b form the sensor cell 26s. Further, the monitor electrode 23m, the solid electrolyte body 22 and the reference electrode 23b form a monitor cell 26m.

The pump cell 26p is used to adjust a concentration of O₂ in the exhaust gas g. The pump electrode 23p in the pump cell 26p decomposes O₂ to generate oxygen ions. The generated oxygen ions are discharged to the reference gas chamber 21 through the solid electrolyte body 22. The pump electrode 23p oxidizes NH₃ to generate NO.

As shown in FIG. 1, the exhaust gas g is introduced into the gas chamber 20 through the gas introduction section 29, and passes through the pump electrode 23p and reaches sensor electrode 23s and the monitor electrode 23m. The closer the exhaust gas g moves to the sensor electrode 23s through the introduction section 29, the more the concentration of O₂ in the exhaust gas g reduces. The closer the exhaust gas g moves to the sensor electrode 23s through the introduction section 29, the more the concentration of NH₃ in the exhaust gas g reduces, and the concentration c₃ of the derived NO increases.

The sensor electrode 23s decomposes NOx to generate oxygen ions, and decomposes NO, which has been generated by oxidization of NH₃. A sensor current Is is generated when the generated oxygen ions flow in the solid electrolyte body 22. This sensor current Is is measured, and the concentration c₁ of the combustion derived NOx and the concentration c₃ of the derived NO are also measured on the basis of the measured sensor current Is.

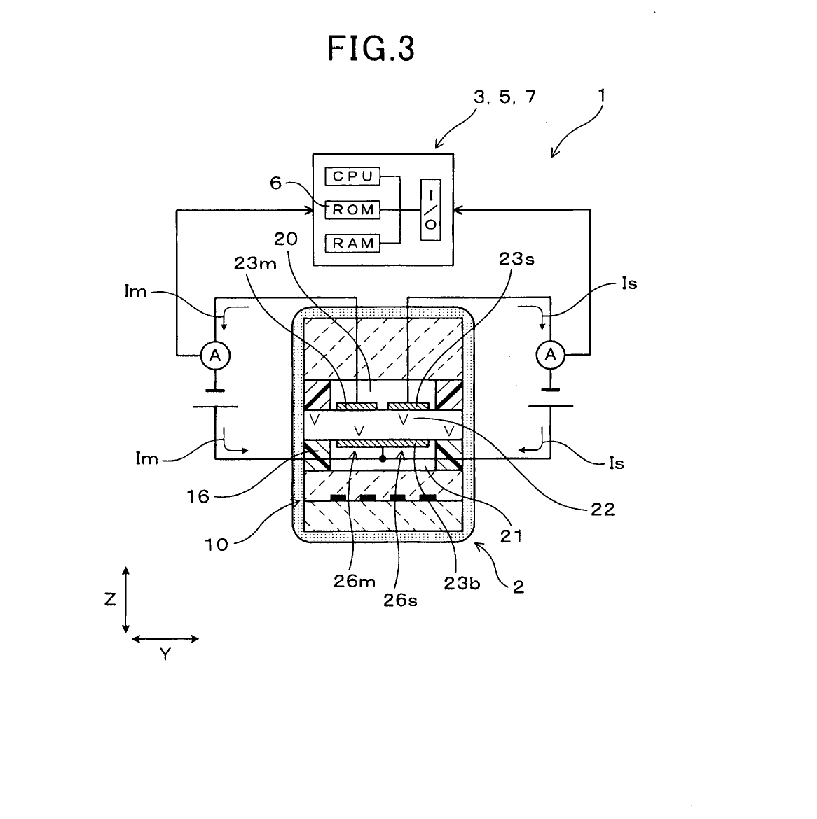

A small amount of O₂, which has not eliminated by the pump cell 26p, is remained in the exhaust gas g on the surface of the sensor electrode 23s. For this reason, it is necessary for the monitor cell 26m to measure and compensate the concentration of the remaining O₂. That is, the monitor current Im is detected, which is generated when the remaining O₂ is decomposed by the monitor electrode 23m (see FIG. 3) and flows in the solid electrolyte body 22. The monitor current I, is subtracted from the sensor current Is. This makes it possible to measure the sum concentration c₄ with high accuracy without receiving the influence of the remaining O₂.

Next, a description will now be given of the NH₃ concentration estimation section 5. For example, as shown in FIG. 6, an upstream side NOx sensor 200 is arranged at the upstream side of the urea water injection valve 8. The upstream side NOx sensor 200 measures the concentration of NOx (the upstream side NOx concentration) in the exhaust gas g. Further, a temperature sensor 210 is arranged to detect a temperature T of the SCR catalyst 81. There is a constant relationship between the upstream side NOx concentration, the temperature T of the SCR catalyst 81, an injection amount of the urea water 80 which has been injected, and the concentration of NH₃ contained in the exhaust gas g at the downstream side of the SCR catalyst 81. That is, the higher the temperature T of the SCR catalyst 81, the faster the chemical reaction between NH₃ and NOx proceeds. When the temperature T of the SCR catalyst 81 is high, a less amount of NH₃ is remained in the exhaust gas at the downstream side.

In addition, when a large amount of the urea water 80 is injected into the exhaust gas g, NH₃ is usually remained in the exhaust gas g at the downstream side. Further, when the upstream side NOx concentration is high, the concentration of NH₃, which is remained in the exhaust gas at the downstream side, is easily reduced. It is accordingly possible to estimate the concentration of NH₃ contained in the exhaust gas g at the downstream side on the basis of these relationships previously described. It is acceptable to use other various methods of estimating the concentration of NH₃. As omitted from the drawings, it is also acceptable to detect the concentration of NH₃ contained in the exhaust gas g by using an additional NH₃ sensor which is arranged at the downstream side of the SCR catalyst 81.

In the NOx sensor used by the first exemplary embodiment, the trap layer 291 has a thickness of not more than 1,200 μm. Each of the trap layer 291 and the diffusion layer 291 has a porosity within a range of 10 to 90%. The gas introduction section 29 in the NOx sensor 2 is used at a temperature within a range of 600 to 850° C.

A description will now be given of effects of the first exemplary embodiment. As previously described, there is the constant relationship between the air fuel ratio A/F of the exhaust gas g, the concentration c₂ of the NH₃ contained in the outside exhaust gas which is present around the NOx sensor, not inside of the NOx sensor, and the concentration c₃ of the derived NO which has been derived from NH₃. For this reason, it is possible to calculate the concentration c₃ of the derived NO on the basis of the detected air fuel ratio A/F of the exhaust gas g and the detected concentration c₂ of the NH₃ contained in the outside exhaust gas. Further, the derived NO which has been derived from NH₃ is subtracted from the sum concentration c₄ (which is a sum of the concentration c₁ of the combustion derived NOx and the concentration c₃ of the derived NO which has been derived from NH₃) measured by the NOx sensor 2. It is possible to measure the concentration c₁ of the combustion derived NOx with high accuracy on the basis of this subtraction.

Similarly, because there is the constant relationship between the concentration of O₂ in the exhaust gas g and the concentration c₃ of the derived NO which has been derived from NH₃, it is possible to calculate the concentration c₃ of the derived NO by measuring the concentration of O₂ and the concentration c₂ of the NH₃ contained in the outside exhaust gas. Further, because there is the constant relationship between the concentration of H₂O in the exhaust gas g, the concentration c₂ of the NH₃ contained in the outside exhaust gas and the concentration c₃ of the derived NO which has been derived from NH₃, it is possible to calculate the concentration c₃ of the derived NO by measuring the concentration of H₂O and the concentration c₂ of the NH₃ contained in the outside exhaust gas. It is therefore possible to calculate the concentration c₁ of the combustion derived NOx with high accuracy by subtracting the obtained concentration c₃ of the derived NO from the sum concentration c₄.

As previously described, the first exemplary embodiment can calculate the concentration c₁ of the combustion derived NOx with high accuracy because the concentration c₃ of the derived NO is calculated by using the concentration c₂ of the NH₃ contained in the outside exhaust gas and one of the air fuel ratio A/F of the exhaust gas g, the concentration of O₂ and the concentration of H₂O, and the concentration c₃ of the derived NO is subtracted from the sum concentration c₄. It is also acceptable to combine the air fuel ratio A/F, the concentration of O₂ and the concentration of H₂O when the concentration c₃ of the derived NO is calculated.

As shown in FIG. 23, if the concentration c₂ of the NH₃ contained in the outside exhaust gas is subtracted from the sum concentration c₄ without calculating the concentration c₃ of the derived NO, there is a high possibility in which the calculated concentration c₁′ of the combustion derived NOx is smaller than the concentration c1 of actual NOx. That is, because a part of NH₃ becomes N₂, the concentration c₃ of the derived NO becomes smaller than the concentration c₂ of the NH₃ contained in the outside exhaust gas. However, the first exemplary embodiment calculates the concentration c₃ of the derived NO with high accuracy, and the calculation result is subtracted from the sum concentration c₄, therefore it is possible to measure the concentration c₁ of the combustion derived NOx with high accuracy.

The first exemplary embodiment performs the subtraction of the concentration c₃ of the derived NO from the sum concentration c₄. However, the concept of the present invention is not limited by the first exemplary embodiment. For example, it is possible to prepare in advance a database storing data regarding the relationship between the sum concentration c₄, the concentration c₃ of the derived NO and the concentration c₁ of the combustion derived NOx, and to obtain with high accuracy the concentration c₁ of the combustion derived NOx by using the database, the sum concentration c₄ and the concentration c₃ of the derived NO. On the other hand, the first exemplary embodiment performs the subtraction previously described without using such a data base, and stores the database into the memory section 6 (see FIG. 1).

When using the concentration of O₂ or the concentration of H₂O, the first exemplary embodiment measures the air fuel ratio A/F, and calculates the concentration of O₂ and the concentration of H₂O by using the detected air fuel ratio A/F. This method can eliminate additional O₂ sensor and H₂O sensor, and produces the NOx concentration measurement system 1 with low manufacturing costs.

It is possible to form the calculation section 7 to calculate the concentration of the derived NO which has been derived from NH₃ by using the concentration of O₂ and the concentration of the NH₃ contained in the outside exhaust gas. Similarly, it is possible to form the calculation section 7 to calculate the concentration of the derived NO by using the concentration of H₂O and the concentration of the NH₃ contained in the outside exhaust gas. Because this structure does not use both the concentration of H₂O and the concentration of O₂, it is possible to simply calculate the concentration of the derived NO, and this accordingly makes it possible to increase a calculation speed to calculate the concentration of the derived NO.

Further, when using the air fuel ratio A/F, the first exemplary embodiment measures the pump cell current Ip which flows in the pump cell 26p of the NOx sensor, and calculates the air fuel ratio A/F by using the measured pump cell current Ip. This structure makes it possible to produce and provide the NOx concentration measurement system 1 with low manufacturing costs.

Still further, the first exemplary embodiment uses the trap layer 291 (see FIG. 1) having a thickness of not more than 1,200 μm. As shown in FIG. 13, when the trap layer 291 has the thickness of not more than 1,200 μm, the NH₃ detection sensitivity of the NOx sensor 2 for detecting NH₃ does not greatly vary due to the thickness of the trap layer 129. If the thickness of the trap layer 129 exceeds 1,200 μm, the NH₃ detection sensitivity of the NOx sensor 2 for detecting NH₃ is reduced because more thermal energy is supplied to the exhaust gas g when the exhaust gas g passes through the trap layer 291, which promotes conversion of NH₃ to N₂. However, when the trap layer 291 has the thickness of not more than 1,200 μm, the NH₃ detection sensitivity of the NOx sensor 2 is not significantly affected by the thickness of the trap layer 291. For this reason, it is possible to measure the concentration c₃ of the derived NO by using the equation (4) previously described.

Still further, the first exemplary embodiment uses the diffusion layer 291 (see FIG. 1) having the thickness of not more than 5 mm. The structure, in which the thickness of the diffusion layer 292 is adequately reduces to be not more than 5 mm, makes it possible to easily reduce variation of the NH₃ detection sensitivity of the NOx sensor 2. Because an amount of the exhaust gas g per unit time period to be introduced into the gas chamber 20 is increased, this structure makes it possible for the large sensor current Is to flow in the sensor cell 26s.

Still further, the first exemplary embodiment uses the trap layer 291 and the diffusion layer 292 which have a porosity within a range of 10 to 90%. This structure makes it possible to easily produce the trap layer 291 and the diffusion layer 292.

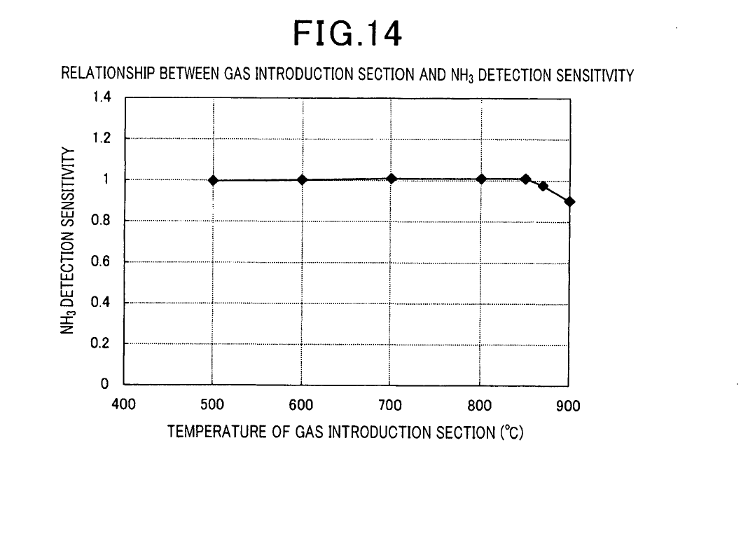

Still further, in the first exemplary embodiment, the gas introduction section 29 (see FIG. 1) has a temperature within a range of 600 to 850° C. when the NOx sensor 2 is used. As shown in FIG. 14, when the gas introduction section 29 is used at a temperature within a range of 600 to 850° C., the NH₃ detection sensitivity of the NOx sensor 2 for detecting NH₃ do not greatly vary due to this temperature of the gas introduction section 29. If the gas introduction section 29 has a temperature of not less than 850° C., the exhaust gas g easily receives thermal energy when the exhaust gas g passes through the gas introduction section 29. In this case, because NH₃ is easily converted to N₂, this structure makes it possible to easily reduce the NH₃ detection sensitivity of the NOx sensor 2 for detecting NH₃. On the other hand, when the gas introduction section 29 has a temperature within a range of 600 to 850° C., this structure makes it possible to reduce the NH₃ detection sensitivity of the NOx sensor 2, and to calculate the concentration c₃ of the derived NO with high accuracy.

It is possible to store into the memory section 6 data items regarding a slope of a graph when the temperature of the gas introduction section exceeds 850° C. shown in FIG. 14. When the temperature of the gas introduction section exceeds 850° C., the NH₃ detection sensitivity of the NOx sensor 2 is calculated by using the graph stored in the memory section 6. In this case, it is acceptable to compensate the concentration c₃ of the derived NO on the basis of the calculation result of the NH₃ detection sensitivity of the NOx sensor 2.

As will be explained later in a second experimental example, there is a constant relationship between a flow speed of the exhaust gas g, and a conversion rate of converting NH₃ to NO. Accordingly, an additional sensor is used for detecting a flow speed of the exhaust gas g, and it is acceptable to compensate the concentration c₃ of the derived NO by using the measured flow speed of the exhaust gas g. This structure makes it possible to calculate the concentration of the combustion derived NOx with high accuracy.

As previously described, the first exemplary embodiment provides the NOx concentration measurement system capable of measuring a concentration of NOx contained in the exhaust gas g which contains NOx and NH₃ with higher accuracy.

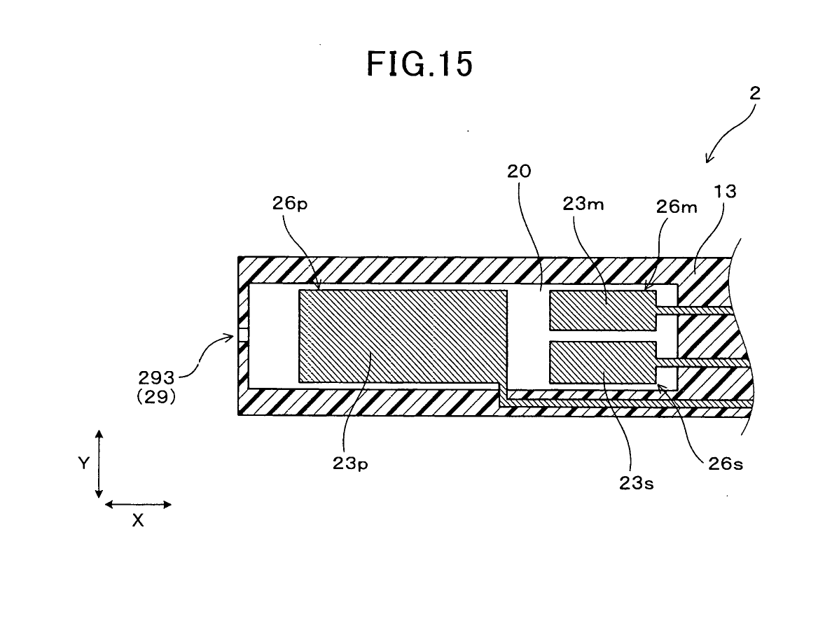

The gas introduction section 29 according to the first exemplary embodiment shown in FIG. 1 has the trap layer 291 and the diffusion layer 292. However, the concept of the present invention is not limited by the first exemplary embodiment. For example, as shown in FIG. 15, it is possible to form an aperture section 293 which allows the gas chamber 20 to communicate with an external space which is outside of the NOx sensor 2 in order to limit the entering speed of the exhaust gas g. When the aperture section 293 is formed in the NOx sensor 2, convection of the exhaust gas g is generated at the aperture section 293, and there is a possible case in which the exhaust gas g receives heat energy supplied from surrounding exhaust gas, and a part of NH₃ in the exhaust gas g is converted to N₂. In this case, it is possible for the present invention to measure the concentration c₁ of the combustion derived NOx with high accuracy. It is acceptable to eliminate the trap layer 291 from the gas introduction section 29.

The first exemplary embodiment uses the NOx sensor 2 to measure the air fuel ratio A/F, and calculate the concentration of O₂ and the concentration of H₂O in the exhaust gas g on the basis of the exhaust gas g. However, the concept of the present invention is not limited by the first exemplary embodiment. For example, it is acceptable to use an additional A/F sensor to detect the air fuel ratio A/F, and calculate the concentration of O₂ and the concentration of H₂O on the basis of the detected air fuel ratio A/F.

### First Experimental Example

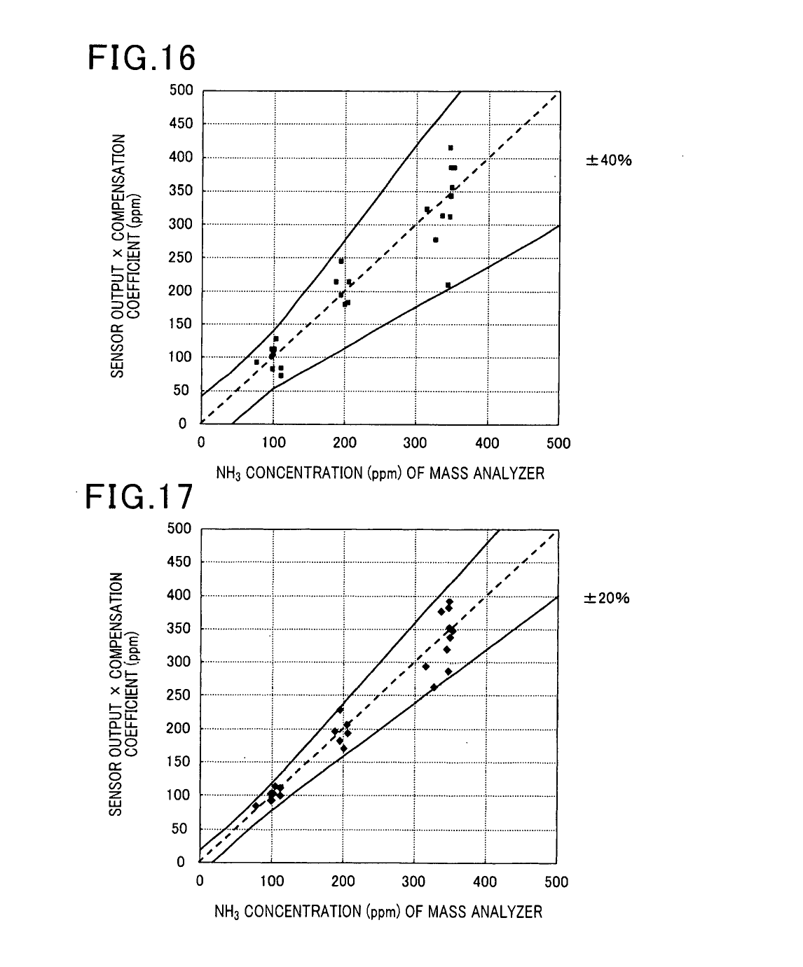

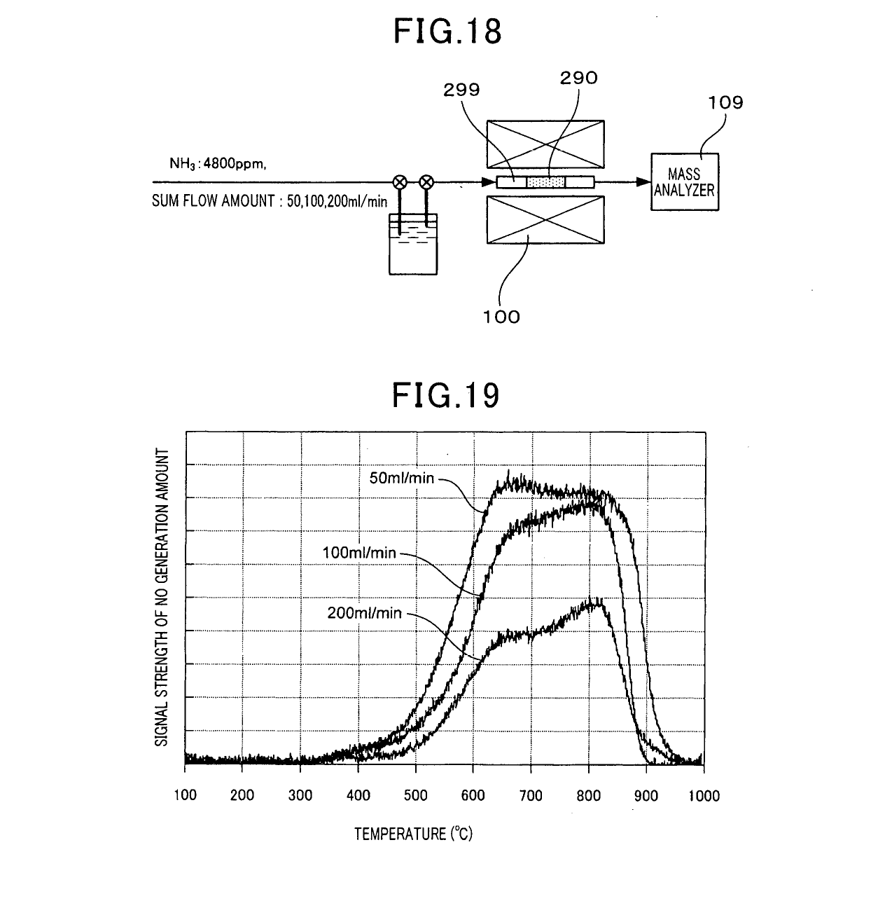

An experiment has been performed to verify the effects of the NOx concentration measurement system according to the present invention. A test gas was prepared, containing NH₃ only without NOx. The NOx sensor 2 having the structure according to the first exemplary embodiment previously described measured a concentration of the test gas. In the measurement of a concentration of the test gas by using the NOx sensor 2, NH₃ contained in the test was converted to NO in the gas introduction section 29. The NOx sensor 2 measured a concentration of the converted NO. Various test gases was prepared to have an NH₃ concentration of 100 ppm, 200 ppm, and 350 ppm, respectively. FIG. 16 and FIG. 17 show a relationship between a concentration of NO, which has been measured by the NOx sensor 2, and a concentration of NH₃ in the test gas.

The experiment shown in FIG. 16 did not compensate the concentration of NO. That is, the experiment shown in FIG. 16 did not perform a multiplication of the concentration of NO measured by the NOx sensor 2 with a NH₃ detection sensitivity previously described. On the other hand, the experiment shown in FIG. 17 has compensated the concentration of NO by using the air fuel ratio A/F. That is, the experiment shown in FIG. 17 has detected the air fuel ratio A/F, and calculated the NH₃ detection sensitivity on the basis of the detected air fuel ratio A/F. Further, the experiment shown in FIG. 17 performed the multiplication of the obtained NH₃ detection sensitivity with the measured concentration of NO.

Both the experiments shown in FIG. 16 and FIG. 17 compensated the measurement values with a compensation coefficient so that an average value of the slope of the graphs thereof was 1.

As shown in FIG. 16, when no compensation to the concentration of NO has performed, the measured values of the concentration of NO have greatly varied. In the graph shown in FIG. 16, the variation of the measurement values becomes approximately 40%. A part of NH₃ has been converted to N₂ due to the influence of O₂ and H₂O present in the test gas. For this reason, when no compensation using the air fuel ratio A/F is performed, the measurement values of the NOx sensor 2 vary due to the variation of the concentration of O₂ and the concentration of H₂O.

On the other hand, as shown in FIG. 17, when performing the compensation by using the air fuel ratio A/F, the obtained concentration of NO has a small variation. In the graph shown in FIG. 17, the variation of the measured values becomes within approximately 20%. Because the case shown in FIG. 17 performed the compensation using the air fuel ratio A/F, the measured values of the NOx sensor 2 were affected by the variation of the concentration of O₂ and the concentration of H₂O. For this reason, it can be considered that the measured values of the NOx sensor 2 have a small variation.

As the experiment previously described, it can be understood for the use of the air fuel ratio A/F to perform with high accuracy the calculation of the concentration of NO which has been converted from NH₃, i.e. the concentration c₃ of the derived NO which has been derived from NH₃. This makes it possible to subtract the accurate concentration c₃ of the derived NO from the sum concentration c₄ which have been measured by the NOx sensor 2 during the measurement of the exhaust gas g which contains NOx and NH₃, and as a result to calculate the concentration c₁ of combustion derived NOx with high accuracy.

### Second Exemplary Experiment

The second exemplary experiment has considered a relationship between a flow speed of the exhaust gas g and a ratio of changing NH₃ contained in the exhaust gas g to NO. Instead of using the gas introduction section 29 of the NOx sensor 2, the second exemplary experiment has prepared a quartz tube 299 and a trap layer 290 made of alumina arranged in the quartz tube 299. The quartz tube 299 has been arranged in the inside of the heater section 10. Test gas which contained NH₃ and N₂, but did not contained NOx was supplied to the quartz tube 299. A mass analyzer 109 was measured a concentration of NO which has been generated by converting NH₃ in the trap layer 290 to NO.

The test gas had the NH₃ concentration of 4,800 ppm and the O₂ concentration of 0% and the H₂O concentration of 0% before supplied to the quartz tube 299. The test gas had the flow speed of 50, 100, and 200 ml³/min. The trap layer 290 had a temperature within a range of 100° C. to 1,000° C. FIG. 19 shows the experimental results of the second exemplary experiment.

As shown in FIG. 19, it can be understood that the higher the flow speed of the test gas, the lower the ratio of converting NH₃ to NO. This means that the exhaust gas passed through the trap layer 290 before the conversion of NH₃ to NO when the flow speed of the test gas is high. The same influence caused by the flow speed of the test gas occurs when the test gas contains O₂ and H₂O.

It can be understood to calculate the concentration c₃ of the derived NO with higher accuracy by measuring the flow speed of the exhaust gas g and performing the compensation of the concentration c₃ of the derived NO on the basis of the measured flow speed of the exhaust gas g. Accordingly, it is possible to more enhance the calculation accuracy of the concentration c₁ of the combustion derived NOx

### Second Exemplary Embodiment

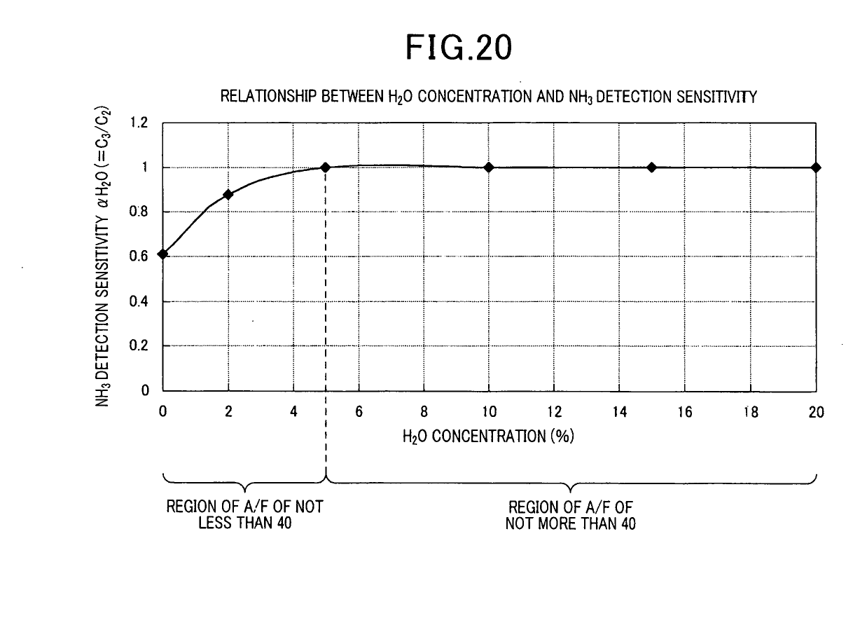

The NOx concentration measurement system according to the second exemplary embodiment selects one of the concentration of H₂O and a concentration of O₂ on the basis of the air fuel ratio A/F of the exhaust gas g. The second exemplary embodiment will be explained with reference to FIG. 20. FIG. 20 shows a graph of the H₂O concentration and the NH₃ detection sensitivity in which the lateral axis is divided into the region having the air fuel ratio A/F of not less than 40 and the region having the air fuel ratio A/F of not more than 40. As can be understood from FIG. 20, in the region having the air fuel ratio A/F of not less than 40, the NH₃ detection sensitivity of the NOx sensor has greatly varied when the H₂O concentration has slightly varied. On the other hand, in the region having the air fuel ratio A/F of not more than 40, the NH₃ detection sensitivity of the NOx sensor did not vary when the H₂O concentration was varied. Accordingly, it is possible to calculate the NH₃ detection sensitivity with high accuracy when the NH₃ detection sensitivity is calculated by using the H₂O concentration during the region having the air fuel ratio A/F of not less than 40, i.e. during the region in which the NH₃ detection sensitivity greatly varies only by a small variation of the H₂O concentration. This makes it possible to measure the concentration c₃ of the derived NO with high accuracy, and to measure the concentration c₁ of the combustion derived NOx with more high accuracy.

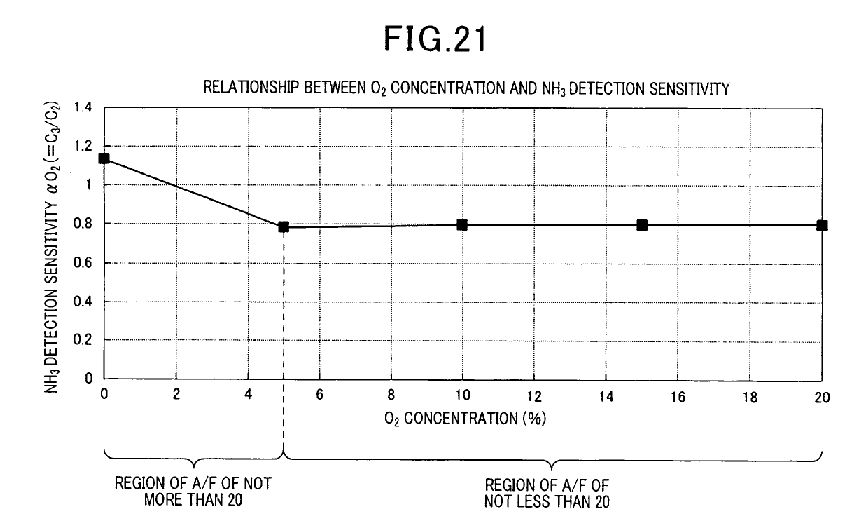

FIG. 21 shows a graph of the O₂ concentration and the NH₃ detection sensitivity in which the lateral axis is divided into the region having the air fuel ratio A/F of not less than 20 and the region having the air fuel ratio A/F of not more than 20.

As can be understood from FIG. 21, in the region having the air fuel ratio A/F of not more than 20, the NH₃ detection sensitivity of the NOx sensor has greatly varied when the O₂ concentration has slightly varied. On the other hand, in the region having the air fuel ratio A/F of not less than 20, the NH₃ detection sensitivity of the NOx sensor has not varied when the O₂ concentration has varied. Accordingly, it is possible to calculate the NH₃ detection sensitivity with high accuracy when the NH₃ detection sensitivity is calculated by using the O₂ concentration in the region having the air fuel ratio A/F of not more than 20, i.e. in the region in which the NH₃ detection sensitivity greatly varies only a small variation of the O₂ concentration. This makes it possible to measure the concentration c₃ of the derived NO with high accuracy, and to measure the concentration c₁ of the combustion derived NOx with more high accuracy.

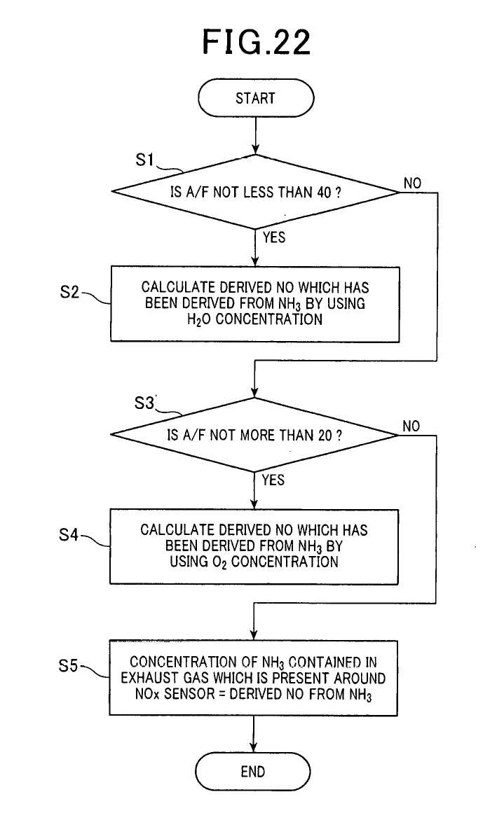

FIG. 22 shows a flow chart of the calculation section 7 (see FIG. 1) according to the second exemplary embodiment. As shown in FIG. 22, it is detected whether the air fuel ratio A/F is not less than 40 in step S1. When the detection result indicates affirmation, i.e. YES, the operation flow progresses to step S2. In step S2, the concentration c₃ of the derived NO is calculated by using the H₂O concentration.

On the other hand, when the detection result indicates negation, i.e. NO, the operation flow progresses to step S3. In step S3, it is detected whether the air fuel ratio A/F is not more than 20. When the detection result indicates affirmation, i.e. YES, the operation flow progresses to step S4. In step S4, the NH₃ concentration is calculated by using the O₂ concentration. When the detection result in step S3 indicates negation, i.e. NO, the operation flow progresses to step S5. In step S5, no compensation is executed, i.e. a multiplication of the concentration c₂ of the NH₃ contained in the outside exhaust gas with the NH₃ concentration is not executed. That is, the concentration c₁ of the combustion derived NOx is calculated under the condition in which the concentration c₂ of the NH₃ contained in the outside exhaust gas and the concentration c₃ of the derived NO have the same value.

As previously described, the second exemplary embodiment selects one having a high calculation accuracy from the O₂ concentration and the NH₃ concentration, and calculates the concentration c₃ of the derived NO by using the selected one. That is, the second exemplary embodiment uses the O₂ concentration when the air fuel ratio A/F is not more than 20, and calculates the NH₃ detection sensitivity. The second exemplary embodiment calculates the concentration c₃ of the derived NO on the basis of the obtained NH₃ detection sensitivity. This structure makes it possible to calculate the concentration c₃ of the derived NO and the concentration c₁ of the combustion derived NOx with high accuracy. In addition to this, the second exemplary embodiment has the same effects of the first exemplary embodiment previously described.

### REFERENCE SIGNS LIST

1 NOx concentration measurement system,
2 Nox sensor,
20 Gas chamber,
21 Reference gas chamber,
26s Sensor cell,
29 Gas introduction section,
3 Detection section,
5 NH₃ concentration estimation section, and
7 Calculation section.

1. A NOx concentration measurement system capable of measuring a concentration of NOx contained in exhaust gas which contains NOx and NH₃, comprising a NOx sensor, a detection section, a NH₃ concentration estimation section, and a calculation section, wherein
the NOx sensor comprises: a gas chamber into which exhaust gas is introduced; a sensor cell having a solid electrolyte body of oxygen ion conductivity having a plate shape, on the surfaces of which electrodes are formed; and a gas introduction section through which the exhaust gas is introduced into the gas chamber,
the NOx sensor measures a sum concentration of a concentration of combustion derived NOx as NOx, which has being contained in the exhaust gas, and a concentration of derived NO which has been derived from NH₃ as a concentration of NO generated by oxidization of the NH₃, and
the detection section detects at least one of an air fuel ratio of the exhaust gas, a concentration of O₂ contained in the exhaust gas and a concentration of H₂O contained in the exhaust gas,
the NH₃ concentration estimation section estimates a concentration of NH₃ contained in outside exhaust gas which is present around the NOx sensor, not inside of the NOx sensor before the outside exhaust gas is introduced into the gas introduction section of the NOx sensor,
the calculation section calculates the concentration of the derived NO which has been derived from NH₃ on the basis of the concentration of the NH₃ contained in the outside exhaust gas and at least one of the air fuel ratio, the concentration of O₂ and the concentration of H₂O, and
the calculation section calculates the concentration of the combustion derived NOx on the basis of the sum concentration and the concentration of the derived NO which has been derived from NH₃.

2. The NOx concentration measurement system according to claim 1, wherein the calculation section subtracts the concentration of the derived NO which has been derived from NH₃ from the sum concentration, and calculates the concentration of the combustion derived NOx by using the subtraction result.

3. The NOx concentration measurement system according to claim 1, wherein the detection section detects the air fuel ratio of the exhaust gas, and calculates at least one of the concentration of O₂ and the concentration of H₂O on the basis of the detected air fuel ratio.

4. The NOx concentration measurement system according to claim 3, wherein the NOx sensor is equipped with a pump cell of adjusting the concentration of O₂ contained in the exhaust gas, and
the detection section is configured to measure a pump cell current which flows in the pump cell to obtain the air fuel ratio of the exhaust gas.

5. The NOx concentration measurement system according to claim 1, wherein the gas introduction section is configured to have a temperature within a range of 600 to 850° C. during the use of the NOx sensor.

6. The NOx concentration measurement system according to claim 1, wherein the gas introduction section of the NOx sensor is composed of at least one of a trap layer and a diffusion layer, where the trap layer has a porosity within a range of 10 to 90% and traps poison material contained in the exhaust gas, and the diffusion layer has a porosity within a range of 10 to 90% and limits a flow speed of the exhaust gas to be introduced into the gas chamber.

7. The NOx concentration measurement system according to claim 6, wherein the trap layer has a thickness of not more than 1200 μm, and the diffusion layer has a thickness of not more than 5 mm.

8. The NOx concentration measurement system according to claim 1, wherein the calculation section is configured to calculate the concentration of the derived NO which has been derived from NH₃ by using the concentration of O₂ and the concentration of the NH₃ contained in the exhaust gas outside of the NOx sensor.

9. The NOx concentration measurement system according to claim 1, wherein the calculation section is configured to calculate the concentration of the derived NO which has been derived from NH₃ by using the concentration of H₂O and the concentration of the NH₃ contained in the exhaust gas outside of the NOx sensor.

10. The NOx concentration measurement system according to claim 1, wherein the calculation section is configured to select one of the concentration of O₂ and the concentration of H₂O so that the calculated concentration of the derived NO which has been derived from NH₃ has a higher accuracy.
